(19) United States
(12) Patent Application Publication
(10) Pub. No.: US 2026/0104430 A1
(43) Pub. Date: Apr. 16, 2026

(54) SPECIMEN PREPARATION DEVICE AND GUIDE MEMBER

(71) Applicant: HIRATA CORPORATION, Kumamoto-shi (JP)

(72) Inventors: Seigo MURAKAMI, Kumamoto-shi (JP); Nobuyuki NAKAGAWA, Kumamoto-shi (JP)

(73) Assignee: HIRATA CORPORATION, Kumamoto-shi (JP)

(21) Appl. No.: 19/390,801

(22) Filed: Nov. 17, 2025

Related U.S. Application Data
(63) Continuation of application No. PCT/JP2023/020163, filed on May 30, 2023.

(51) Int. Cl. G01N 35/00

(52) U.S. Cl. CPC G01N 35/00584

(57) ABSTRACT

A specimen preparation device configured to prepare an observation specimen by providing an observation object placed in a liquid reservoir formed on a light transmissive plate to the plate while guiding the observation object to a predetermined position by a guide member, the specimen preparation device comprising a plurality of holding means, each configured to be able to hold the plate, the guide member being attachable to each holding means, moving means configured to be able to sequentially move the plurality of holding means to a providing position for providing the observation object, and control means configured to identify the guide member attached to each holding means at an identification position and perform control for preparing the observation specimen on a basis of a result of the identification.

### CROSS-REFERENCE TO RELATED APPLICATION(S)

This application is a continuation of International Patent Application No. PCT/JP2023/020163 filed on May 30, 2023, the entire disclosures of which is incorporated herein by reference.

### TECHNICAL FIELD

The present invention mainly relates to a specimen preparation device.

### BACKGROUND ART

An observation specimen used for microscopic observation or the like is generally prepared by providing an observation object such as a tissue piece on a light transmissive plate also referred to as a microscope slide or the like (see Patent Literature 1).

### CITATION LIST

### Patent Literatures

PTL1: Japanese Patent Laid-Open No. 2010-266394

### SUMMARY OF INVENTION

### Technical Problem

In preparing a specimen, an observation object is preferably fixed at a predetermined position on a plate, and a technique for adjusting the fixing position according to the type such as the shape of the observation object can be generally required.

An illustrative object of the present invention is to more appropriately prepare the observation specimen.

### Solution to Problem

One aspect of the present invention relates to a specimen preparation device, and the specimen preparation device is a specimen preparation device that prepares an observation specimen by providing an observation object placed in a liquid reservoir formed on a light transmissive plate to the plate while guiding the observation object to a predetermined position by a guide member, the specimen preparation device includes:
a plurality of holding means, each configured to be able to hold the plate, the guide member being attachable to each holding means;
moving means capable of sequentially moving the plurality of holding means to a providing position for providing the observation object; and
control means that identifies the guide member attached to each holding means at an identification position and performs control for preparing the observation specimen on the basis of a result of the identification.

### Advantageous Effects of Invention

According to the present invention, an observation specimen can be more appropriately prepared.

### BRIEF DESCRIPTION OF DRAWINGS

FIG. 1 is a perspective view illustrating a configuration example of a specimen preparation system.

FIG. 2 is a schematic view illustrating an example of a work mode by a specimen preparation device.

FIG. 3 is a block diagram illustrating a configuration example of the specimen preparation system.

FIG. 4 is a perspective view of a structure of a unit for providing an observation object and a peripheral portion thereof, the structure in which a cover member is not illustrated.

FIG. 5 is a perspective view illustrating an example of a structure of a single holding unit.

FIG. 6 is a perspective view illustrating a configuration example capable of realizing detection and identification of a guide member.

FIG. 7 is a schematic view illustrating some examples of a guide member attachable to the holding unit.

FIG. 8 is a perspective view illustrating an example of a structure of a certain guide member.

FIG. 9A is a perspective view of the holding unit in an attached state.

FIG. 9B is a perspective view of a state in which a plate PL is held by the holding unit in the attached state.

FIG. 9C is a schematic cross-sectional view taken along a line d1-d1 in FIG. 9B.

FIG. 10 is a flowchart illustrating a procedure when preparing a specimen.

### DESCRIPTION OF EMBODIMENTS

Hereinafter, embodiments will be described in detail with reference to the accompanying drawings. Note that the following embodiments do not limit the invention according to the claims, and all combinations of features described in the embodiments are not necessarily essential to the invention. Two or more features of a plurality of features described in the embodiments may be arbitrarily combined. In addition, the same or similar configurations are denoted by the same reference signs, and redundant description will be omitted.

### Regarding Specimen Preparation System

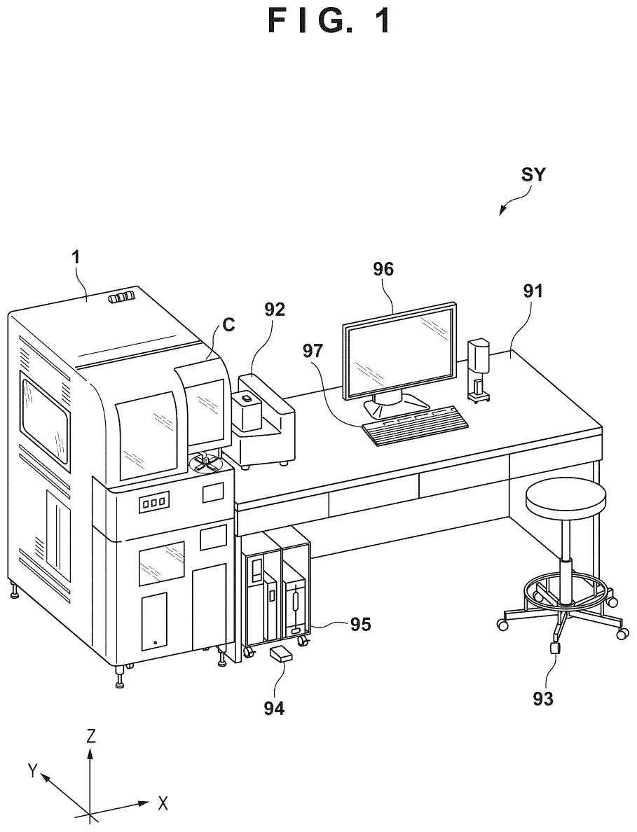

FIG. 1 is a perspective view illustrating an overall configuration example of a specimen preparation system SY according to an embodiment. The system SY includes a specimen preparation device 1, a working table 91, an observation object preparation device 92, a chair 93, an input device 94, a computer 95, a display terminal 96, and an input terminal 97.

In the drawing, an X direction, a Y direction, and a Z direction intersecting each other are illustrated for easy understanding (They may also be illustrated in other drawings described below.). The X direction is one direction in the horizontal direction of the specimen preparation device 1, and corresponds to the left-right direction or the width direction. The Y direction is another direction orthogonal to the one direction in the horizontal direction of the specimen preparation device 1, and corresponds to the front-back direction or the depth direction. The Z direction is a vertical direction of the specimen preparation device 1 and corresponds to the up and down direction or the height direction. For example, the side in the −Y direction corresponds to the front side, and the side in the +Y direction corresponds to the back side. In addition, for example, the side in the +Z direction corresponds to the upper side, and the side in the −Z direction corresponds to the lower side.

Although details will be described later, the specimen preparation device 1 prepares a predetermined observation specimen using an observation object provided by an entity performing the work. Here, the observation object is a tissue piece obtained by slicing a block formed by solidifying a tissue collected from a subject such as a patient with paraffin or the like (observation object OB to be described later). The observation specimen is prepared by placing the observation object on a light transmissive plate (observation specimen SPL to be described later). This plate can also be expressed as a microscope slide, a specimen plate, an observation object placing plate, an optical observation plate, or the like (a plate PL to be described later).

The entity performing the work is an entity that performs work related to specimen preparation, and is typically a worker such as an engineer, but may be a work robot including a provision mechanism (manipulator or the like) for providing an observation object. In the present embodiment, the entity performing the work is referred to as a “worker”, and hereinafter, simply referred to as a “worker”.

The working table 91 is a desk for the worker to perform work accompanying the preparation of the observation specimen. The observation object preparation device 92, the display terminal 96, and the input terminal 97 are installed on the working table 91. Using them, the worker can also perform other work, for example, work of recording or managing information related to the observation specimen on the working table 91. The specimen preparation device 1 and the working table 91 are arranged side by side in the X direction, that is, the working table 91 is installed on the side (here, the side in the +X direction) of the specimen preparation device 1.

In the present embodiment, the observation object preparation device 92 is a microtome for preparing a tissue piece as an observation object, but as another embodiment, for example, another device such as a medical device or an experimental device may be used. The observation object preparation device 92 is installed on the specimen preparation device 1 side on the working table 91.

In the present embodiment, the chair 93 is a chair with casters. As a result, when the worker performs work, the worker can easily move back and forth between the specimen preparation device 1 and the working table 91 while sitting on the chair 93.

In the present embodiment, the input device 94 is a foot switch installed below the working table 91, and the worker can perform an operation input by pressing the input device 94 with his/her foot. The input device 94 is electrically connected to the specimen preparation device 1 by a cable (not illustrated), and although details will be described later, the specimen preparation device 1 proceeds the work step in response to the operation input to the input device 94.

As another embodiment, the input device 94 may be wirelessly connected to the specimen preparation device 1. In addition, as another embodiment, the input device 94 may be installed on the working table 91. Furthermore, instead of the foot switch, a lever, a joystick, or the like operated by a hand or a foot of the worker may be adopted, or various motion sensors or the like operated by movement of a head, an eye, a hand, or a foot may be adopted. Furthermore, the input device 94 may be a device that performs input by recognizing voice, thought, and the like of the worker.

The computer 95 is a general-purpose computer, and here, is installed at a lower place of the working table 91, but is only required to be installed at a position where the worker can be prevented from erroneously interfering with the computer 95. A known display or monitor such as a liquid crystal display is only required to be used as the display terminal 96. A known input operator such as a keyboard or a mouse is only required to be used as the input terminal 97. For example, the worker can perform information management related to the observation specimen using the input terminal 97 while visually recognizing the plate and the information indicating the observation object with the display terminal 96.

### Regarding Specimen Preparation Device

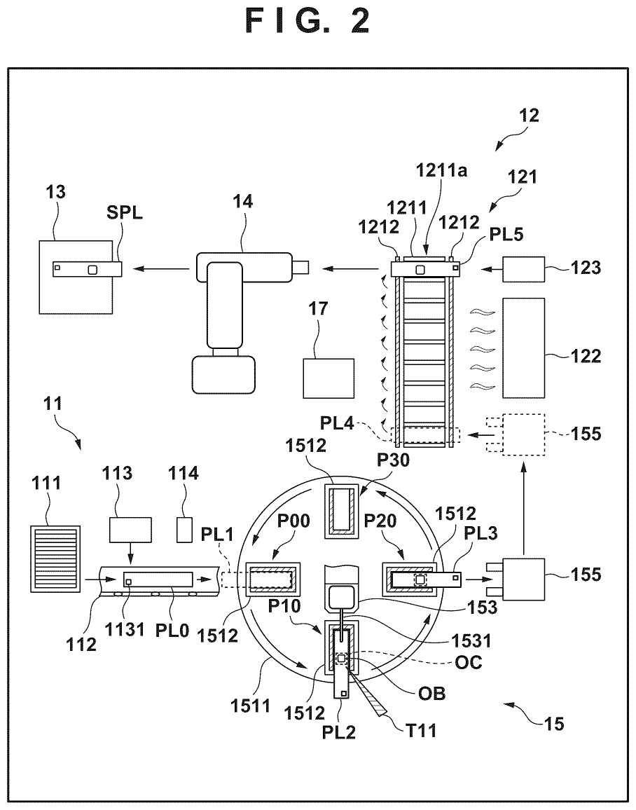

FIG. 2 is a schematic diagram illustrating an example of a configuration capable of realizing specimen preparation work in the specimen preparation device 1. The specimen preparation device 1 includes a pre-processing unit 11, a post-processing unit 12, a specimen storage unit 13, a transfer unit 14, and an observation object provision unit 15. In addition, the specimen preparation device 1 further includes a cover member C that is openable and closable between the inside of the housing and the outside of the housing, and the pre-processing unit 11, the post-processing unit 12, the specimen storage unit 13, the transfer unit 14, and a part of the observation object provision unit 15 are arranged in the housing. Although details will be described later, the pre-processing unit 11 includes units 111 to 114 that perform pre-processing that is processing before provision of the observation object. In addition, the post-processing unit 12 includes units 121 to 123 that perform post-processing that is processing after provision of the observation object.

The specimen storage unit 13 is a unit that stores (or houses or keeps) the prepared observation specimen. The specimen storage unit 13 may be simply expressed as a storage unit, or may be expressed as a specimen housing unit (or simply a housing unit), a specimen keeping unit (or simply a keeping unit), or the like.

In the present embodiment, the transfer unit 14 is a manipulator capable of gripping the plate, and receives the plate PL to which the observation object is provided from the post-processing unit 12 as the observation specimen SPL and transfers the plate PL to the specimen storage unit 13.

Although details will be described later, the observation object provision unit 15 is configured to be accessible when the worker provides the observation object to the plate PL. The unit 15 is installed at an access point (It is referred to as an observation object providing position or simply, a providing position P10.) by the worker at the time of providing the observation object so that at least the providing position P10 is exposed to the outside of the housing of the specimen preparation device 1. As a result, the worker can access the unit 15 and provide the observation object prepared by the observation object preparation device 92 to the plate PL at the providing position P10.

The unit 15 may be expressed as a unit for the entity performing the work access or the like from the viewpoint of an access target by the worker, or may be expressed as an observation object reception unit or the like from the viewpoint of receiving an observation object from the worker.

The cover member C is used in a closed state during preparation of the specimen. In addition, the cover member C is used in an open state during maintenance of the specimen preparation device 1, supply of a new plate PL, or a preparatory stage of specimen preparation (replacement work of a guide member 411 to be described later).

The specimen preparation device 1 further includes a control unit 17. For example, the control unit 17 performs drive control of the pre-processing unit 11, the unit 15, and the post-processing unit 12, and also performs management control of the entire specimen preparation device 1. In addition, the control unit 17 performs dedicated drive control for driving the transfer unit 14. The control unit 17 may be formed by being divided into a plurality of units.

### Regarding Work Mode of Specimen Preparation by Specimen Preparation Device

A work mode of specimen preparation by the specimen preparation device 1 will be described with reference to FIG. 2.

### Regarding Pre-processing Unit 11

The pre-processing unit 11 includes a plate storage unit 111, a transport unit 112, a printing unit 113, and a reading unit 114. The plate storage unit 111 is a magazine (It may be expressed as a cartridge, a cassette, or the like.) that stores the plate PL before the observation object OB is provided, that is, the cleaned or unused plate PL to be used for preparing the observation specimen SPL. The plate storage unit 111 stores a plurality of plates PL, and can sequentially feed the plurality of plates PL one by one to the transport unit 112.

The transport unit 112 is a transport belt in the present embodiment, and transports the plates PL fed from the plate storage unit 111 one by one toward the unit 15.

In the present embodiment, the printing unit 113 is an inkjet type recording head, performs printing on the plate PL being transported by the transport unit 112, and provides, for example, predetermined identification information 1131 (For understanding, this plate PL is illustrated as the plate PL0 in the drawing.). For example, a two-dimensional code is used as the identification information 1131, but alternatively/incidentally, a letter, a number, a symbol, a figure, or the like may be used.

The reading unit 114 reads the identification information 1131 provided to the plate PL0, and outputs its result to the computer 95. The computer 95 can also cause the display terminal 96 to display contents indicating the identification information 1131. As a result, it is possible to associate the identification information 1131 with the observation object (information on) provided to the plate PL to which the identification information is attached, and to individually manage these pieces of information.

### Regarding Observation Object Provision Unit 15

The observation object provision unit 15 includes a rotation support table (moving support table) 1511, a plurality of (here, four) holding units 1512, a liquid supply unit 153, and a transfer unit 155. The rotation support table 1511 is configured to be rotatable about its center as a rotation axis, and rotates by a predetermined angle according to an operation input to the input device 94. The plurality of holding units 1512 is typically installed at equal intervals around the rotation axis, and is sequentially moved to the providing position P10 according to the operation input to the input device 94, for example.

In the present embodiment, since the four holding units 1512 are installed at equal intervals, one rotation angle of the rotation support table 1511 by the operation input to the input device 94 is set to 90 degrees. For easy understanding, one of the plurality of holding units 1512 will be described below with attention being paid.

First, a certain holding unit 1512 receives the plate PL to which the identification information 1131 is provided from the transport unit 112 at a reception position P00 and holds the plate PL (For distinction, this plate PL is illustrated as the plate PL1 in the drawing.).

Next, the holding unit 1512 holding the plate PL1 is moved to the providing position P10 by rotation of the rotation support table 1511. As a result, the worker can provide the observation object OB to the plate PL1 using a tool T11 such as tweezers (For distinction, this plate PL is illustrated as a plate PL2 in the drawing.). In addition, when the holding unit 1512 that holds the plate PL1 is moved to the providing position P10, the holding unit is brought into an inclined posture inclined at a predetermined angle (inclination angle) so that the rotation center axis direction side of the rotation support table 1511 becomes lower. The inclination angle in the present embodiment may be, for example, about 0.5 to 5 [degrees], and is about 1 [degree] in the present embodiment.

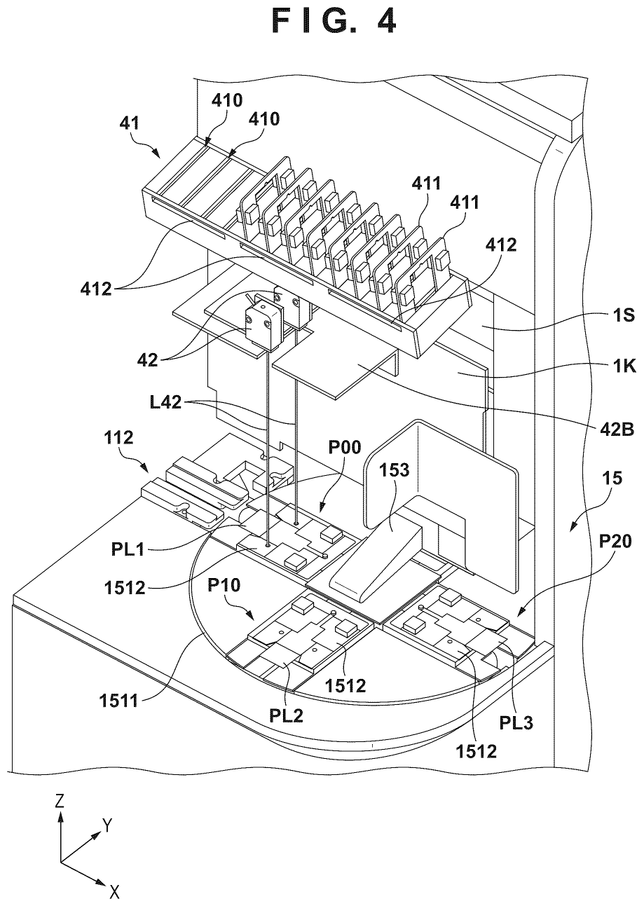

Here, the liquid supply unit 153 can supply liquid from a nozzle 1531, and the liquid is supplied onto the plate PL2 in the inclined posture at the providing position P10 when the observation object OB is provided. As the liquid, a solution or a chemical liquid having substantially no chemical influence on the observation object OB may be used, and pure water is used in the present embodiment, but physiological saline or the like may be used as another embodiment. Although details will be described later, a guide member 411 (see FIG. 4) is attached to the holding unit 1512, so that a liquid reservoir is formed on the plate PL2 when liquid is supplied from the nozzle 1531.

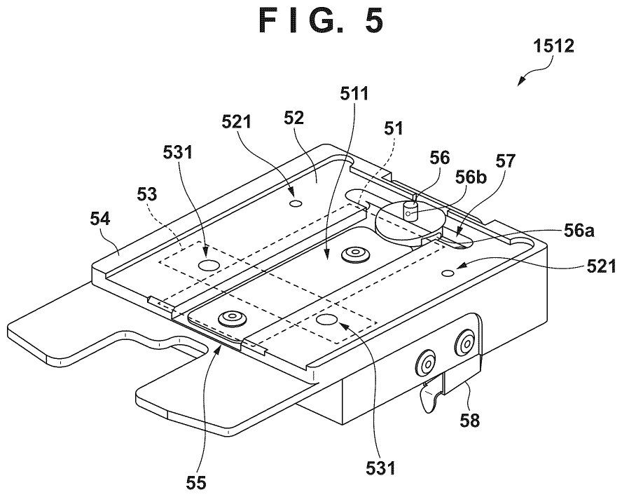

When the worker places the observation object OB on the supplied liquid, the observation object OB is placed on the supplied liquid to spread appropriately (without generating wrinkles or the like) on the plate PL2. Thereafter, although details will be described later, the supplied liquid is discharged by a liquid discharge portion 56 (see FIG. 5) provided on the rotation shaft side of the rotation support table 1511. When the liquid between the plate PL2 and the observation object OB is discharged, the observation object OB can be fixed to a fixing position OC virtually set on the plate PL2. Specifically, when the liquid between the plate PL2 and the observation object OB is discharged, the liquid flows while being guided by the guide member 411, and the observation object OB approaches and sits on the fixing position OC virtually set on the plate PL2 along with the flow of the discharged liquid, so that the observation object OB can be fixed.

Next, the plate PL2 to which the observation object OB has been provided moves to a delivery position P20 for delivering the plate PL2 to the transfer unit 155 by further rotation of the rotation support table 1511 (For distinction, this plate PL2 is illustrated as a plate PL3 in the drawing.). The inclined posture of the holding unit 1512 moved to the delivery position P20 is released and returned to the horizontal posture. In this state, although details will be described later, the transfer unit 155 receives the plate PL3 from the holding unit 1512 and transfers the plate PL3 to the post-processing unit 12. Thereafter, the holding unit 1512 that has transferred the plate PL3 to the transfer unit 155 moves to the reception position P00 again by two times of rotation.

Note that a position P30 as a position between the delivery position P20 and the reception position P00 and as a position on the opposite side of the providing position P10 may be used for cleaning or the like of the holding unit 1512. As another embodiment, the delivery of the plate PL3 to the transfer unit 155 may take place at the position P30 instead of the position P20.

### Regarding Post-Processing Unit 12

The post-processing unit 12 includes a heating unit 122 and a confirmation unit 123. In addition, the post-processing unit 12 further includes a transfer unit 121 that transfers the plate PL in the heating unit 122. The transfer unit 121 is a walking beam type transfer device in the present embodiment, and includes a specimen placement portion 1211 and a specimen transfer mechanism 1212. The specimen placement portion 1211 is an elongated plate material capable of placing a plurality of plates PL with the observation object OB one by one at a predetermined position.

The specimen transfer mechanism 1212 includes a pair of beam members arranged on both sides of the specimen placement portion 1211 and a drive mechanism for driving the beam members. By driving by the drive mechanism, the pair of beam members simultaneously moves up and down and horizontally in parallel. Specifically, the pair of beam members are continuously operated in the order of rising, movement in one direction of transport (feeding operation), lowering, and movement in the other direction of transport (returning operation), whereby the plate PL on the specimen placement portion 1211 is intermittently transferred in one direction.

With such a configuration, the transfer unit 121 receives the plate PL3 from the transfer unit 155 (For distinction, a plate PL4 is shown in the drawing.) and transfers the plate PL3 to a transfer end portion 1211a (For distinction, a plate PL5 is illustrated in the drawing.).

The specimen placement portion 1211 may be simply expressed as a placement portion. In addition, the specimen transfer mechanism 1212 may be simply expressed as a transfer mechanism, or may be expressed as a specimen transport mechanism (or simply a transport mechanism) or the like.

The heating unit 122 is installed below the specimen placement portion 1211 and heats the plate PL4 placed on the specimen placement portion 1211 and the observation object OB thereon. As a result, the observation object OB is extended as the liquid content on the plate PL4 evaporates by heating. The heating unit 122 may be expressed as a temperature processing unit or the like, or may be expressed as a temperature processing unit, an observation object extending unit, or the like from the similar viewpoint.

The confirmation unit 123 is disposed at the transfer end portion 1211a of the specimen placement portion 1211, and confirms the state of the observation object OB (that is, the observation specimen SPL) on the plate PL5 transferred to the transfer end portion 1211a while being heated by the heating unit 122. A known imaging device may be used as the confirmation unit 123, and a known lighting device may be incidentally used.

For example, the confirmation unit 123 images the observation object OB on the plate PL5, records the observation object OB as image information, and associates the observation object OB with the identification information 1131. In addition, the confirmation unit 123 can confirm the processing state of the observation object OB on the plate PL5 and perform predetermined determination, and can also output a result of confirmation and determination to the computer 95. As a result, the observation object OB on the plate PL5 can be appropriately managed as the observation specimen SPL by the identification information 1131 attached to the plate PL5 together with the information indicating the result of the confirmation and the determination. The computer 95 can also cause the display terminal 96 to display information indicating whether the observation specimen SPL is appropriately prepared. As another embodiment, the confirmation and determination may be executed by the computer 95. In addition, by displaying the image on the display terminal 96, the worker can visually confirm the observation object OB on the plate PL5.

Thereafter, the plate PL5 is transferred to the specimen storage unit 13 by the transfer unit 14 as the observation specimen SPL together with the observation object OB provided thereto.

### Regarding Configuration of Specimen Preparation System

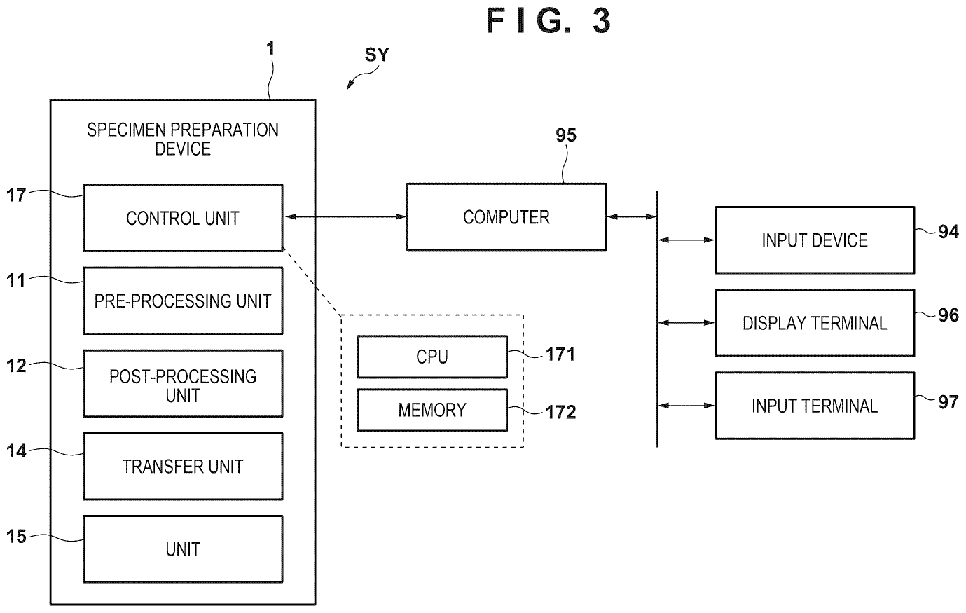

FIG. 3 is a block diagram illustrating a configuration example of the specimen preparation system SY. The computer 95 is connected in a communication-enabling manner to the input device 94, the display terminal 96, the input terminal 97, and the specimen preparation device 1, and the specimen preparation device 1 executes the specimen preparation operation on the basis of the communication with the computer 95.

For example, the worker can perform operation input using the input terminal 97, and for example, can set information related to specimen preparation as setting information prior to the specimen preparation. In addition, for example, the worker can perform operation input using the input device 94, and for example, can instruct necessary operation on the specimen preparation device 1 at the time of specimen preparation. The computer 95 outputs a control signal to the specimen preparation device 1 on the basis of the operation input, and outputs information to be presented to the worker at that time to the display terminal 96. Note that the input terminal 97 and the display terminal 96 may be integrally configured.

The specimen preparation device 1 controls driving of the pre-processing unit 11, the post-processing unit 12, the transfer unit 14, and the observation object provision unit 15 by the control unit 17, and sequentially prepares the observation specimen SPL by the procedure described with reference to FIG. 2.

In the present embodiment, the control unit 17 includes a central processing unit (CPU) 171 and a memory 172, and the setting information set using the input terminal 97 can be stored in the memory 172 by communication with the computer 95. In addition, the control unit 17 reads a program for executing specimen preparation from the memory 172, executes the program by the CPU 171, and performs the drive control on the basis of the setting information stored in the memory 171. Note that the setting information may be stored in another storage device such as an SSD.

Note that the control unit 17 may typically be configured to incorporate a control base on which electronic components such as an application specific integrated circuit (ASIC) are mounted. That is, each function of the control unit 17 may be realized by either hardware or software.

### Mode of Providing Observation Object on Plate

FIG. 4 is a perspective view of a structure of the observation object provision unit 15 and a peripheral portion thereof, the structure in which the cover member C is not illustrated. In the specimen preparation device 1, a housing table 41 for housing the guide member 411 is installed above the unit 15. In addition, a sensor 42 is installed between the unit 15 and the housing table 41 so as to be located above the reception position P00. The specimen preparation device 1 further includes a housing installation portion 1S in which the housing table 41 is provided and a sensor installation portion 1K in which the sensor 42 is installed. The housing installation portion 1S is set above the unit 15 so as to be arranged at a height that the worker sitting on the chair 93 can reach by hand.

The housing table 41 is formed in a box shape, and includes a housing portion 410 that houses the plurality of guide members 411 for each type, and an identification display portion 412 that indicates the type of the guide member 411 housed in the housing portion 410.

Although details will be described later, the guide member 411 is formed in a plate shape having a predetermined outer shape. In addition, a plurality of the housing portions 410 is formed in a slit shape on the upper surface of the housing table 41 and arranged side by side, and each houses the guide member 411 so as to be insertable and removable. The slit into which the guide member 411 can be inserted and removed may be formed to be inclined with respect to the Z direction, so that the guide member 411 can be held in a posture inclined by a predetermined angle. In the present embodiment in which the housing portion 410 has a slit shape, the slit of the housing portion 410 is formed to be inclined so that the guide member 411 can be easily inserted and removed while the worker is seated on the chair 93. This improves work efficiency.

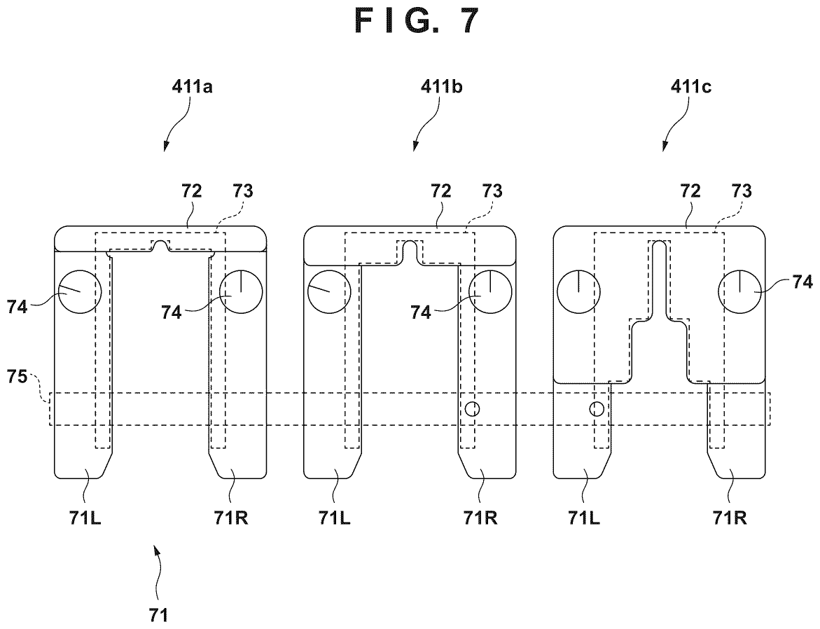

The identification display portion 412 is arranged corresponding to the housing position of each type of the guide member 411. Although details will be described later, in this example, three types of guide members 411 (see FIG. 7) are arranged in a distinguishable manner. As described above, the different types of guide members 411 can be collectively stored and managed in the housing table 41 in advance according to the type of the observation specimen SPL prepared by the specimen preparation device 1, so that the storage and management of the guide member 411 is facilitated and the preparation efficiency of the different types of observation specimens SPL is improved.

The sensor 42 is attached to the sensor installation portion 1K via an attachment portion 42B above the reception position P00. As the sensor 42, for example, an optical sensor such as a laser or an infrared sensor can be used. The sensor 42 is positioned such that its optical axis L42 passes through the holding unit 1512 at the reception position P00. With such a configuration, the sensor 42 detects the guide member 411 attached to the holding unit 1512 at the reception position P00, and thus, in a case where the guide member 411 is attached, the type thereof can be further specified. Although details will be described later, the reception position P00 can also be expressed as an identification position P00 from this viewpoint.

FIG. 5 is a perspective view illustrating an example of a structure of the single holding unit 1512, and illustrates the holding unit 1512 in a non-attached state in which the guide member 411 is not attached. The holding unit 1512 includes a placement portion 51, an attachment portion 52, an identification assist portion 53, a regulation portion 54, the liquid discharge portion 56, and a liquid discharge path 57. In addition, the holding unit 1512 includes a reception portion 55 for receiving the plate PL. In addition, the holding unit 1512 includes a tilting mechanism 58 that moves the holding unit 1512 to the horizontal posture and the horizontal posture.

The placement portion 51 is formed such that the plate PL can be placed on the upper surface of the main body of the holding unit 1512. The placement portion 51 is provided with a recessed portion 511 recessed with respect to a placement surface (plate contact surface) on which the plate PL is placed in contact. Although details will be described later, the recessed portion 511 is continuously formed toward the liquid discharge portion 56.

The attachment portion 52 is provided so as to surround the placement portion 51, and a pair of attachment portions is provided substantially on both sides of the placement portion 51. The attachment portion 52 includes a screw hole 521 for attaching the guide member 411, and the guide member 411 is attached and fixed to the attachment portion 52 by screwing. A pair of screw holes 521 is provided on both sides of the placement portion 51, and can function as an alignment portion for aligning the guide member 411. As another example, the guide member 411 may be fixed by a magnet or the like, or may be simply fitted, engaged, or locked.

Note that the guide portion contact surface with which the guide member 411 comes into contact and the plate contact surface with which the plate PL comes into contact are formed on the same surface.

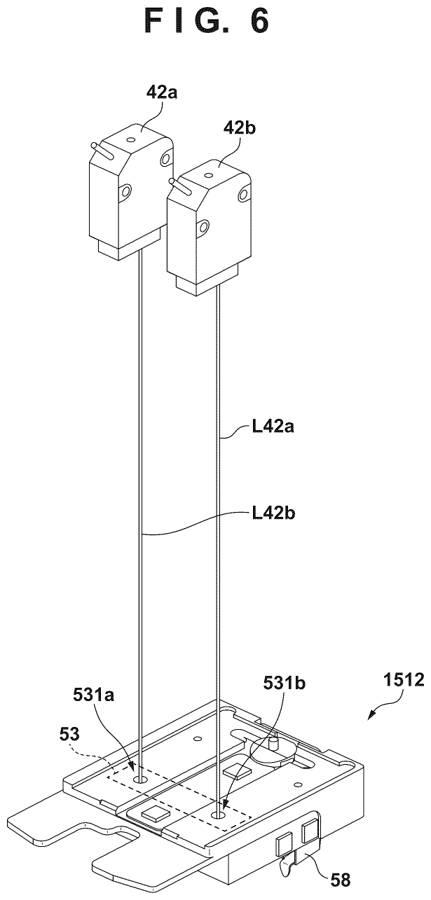

The identification assist portion 53 includes an opening portion 531 used to assist the identification of the guide member 411 when the guide member 411 has been attached. A pair of the opening portions 531 is provided on both sides of the placement portion 51, and a pair of the sensors 42 can also be provided corresponding to the opening portions. Although details will be described later, with such a configuration, the pair of sensors 42 detects the presence or absence of the pair of opening portions 531 (see FIG. 6). The control unit 17 determines the presence or absence of the guide member 411 on the basis of the detection results of the sensors 42, and identifies the type of the guide member 411 if any guide member exists.

The reception portion 55 is provided in a shape opened so as to be able to receive the plate PL received from the transport unit 112 at the reception position P00, and can also be expressed as a reception port 55. The reception portion 55 can function as an insertion port of the plate PL and also function as a part of the placement portion 51.

The regulation portion 54 is a wall portion formed so as to surround a region enclosing the guide portion contact surface and the plate contact surface, and is provided so as to regulate the position of the guide member 411 having a predetermined size. Specifically, the regulation portion 54 is provided by a rectangular wall portion forming three sides excluding one side on the reception portion 55 side. By providing such a wall portion, liquid can be accumulated on the placement portion 51 when the holding unit 1512 (placement portion 51) is inclined. In addition, the regulation portion 54 formed by such a wall portion can function as an alignment portion for aligning the guide member 411 and also function as a part of the attachment portion 52. Note that alignment of the guide member 411 by the regulation portion 54 can be realized by the edge portion of the guide member 411 abutting on the wall portion forming the regulation portion 54.

The liquid discharge portion 56 is provided at a position facing the reception portion 55 (on the opposite side of the reception portion 55), and is configured to be able to discharge the liquid supplied from the nozzle 1531 of the liquid supply unit 153 at the providing position P10 after the observation object OB is placed on the liquid. The liquid discharge portion 56 can also be used to align the plate PL inserted from the reception portion 55. The liquid discharge portion 56 can also function as an alignment portion for aligning the plate PL and can also function as a part of the placement portion 51. The liquid discharge portion 56 includes a liquid discharge port 56a for liquid collected in the liquid discharge path 57 to be described later. In addition, the liquid discharge portion 56 includes a liquid discharge port 56b for liquid supplied onto the plate PL placed on the placement portion 51. The liquid discharge port 56a and the liquid discharge port 56b are provided to communicate with each other, and communicate with a liquid discharge collection unit (not illustrated). The liquid supplied from the nozzle 1531 at the providing position P10 flows on the plate PL, is discharged through the liquid discharge port 56b to the liquid discharge collection unit (not illustrated), and is collected.

The liquid discharge path 57 is provided so as to be connected to the liquid discharge portion 56 while communicating with the recessed portion 511. The excess liquid supplied from the nozzle 1531 at the providing position P10 is collected in the liquid discharge path 57 through the recessed portion 511 and/or flows on the plate PL and is collected in the liquid discharge path 57. Thereafter, the liquid is discharged to the liquid discharge collection unit (not illustrated) through the liquid discharge port 56a and collected.

The tilting mechanism 58 is configured to be able to tilt the main body of the holding unit 1512 including the placement portion 51, and can, for example, bring the placement portion 51 into a horizontal posture or an inclined posture on the basis of a control signal from the control unit 17. When the placement portion 51 is in the horizontal posture, the reception portion 55 can receive the plate PL from the transport unit 112, and when the placement portion 51 is in the inclined posture, the liquid discharge portion 56 is positioned lower than the reception portion 55. That is, the tilting mechanism 58 can execute the tilting movement of the placement portion 51, so that the reception portion 55 can move between a position (first position: horizontal posture) for receiving the plate PL from the transport unit 112 and a position (second position: inclined posture) where the liquid discharge portion 56 is positioned lower than the reception portion 55.

In the present embodiment, the tilting mechanism 58 is only required to be configured such that the posture of the placement portion 51 can be changed bidirectionally from one of the horizontal posture and the inclined posture to the other, and a known configuration may be adopted. For example, the tilting mechanism 58 may include a motor connected to a rotating shaft that pivotally supports the lower portion of the holding unit 1512, and a motor driver that drives the motor to rotate the holding unit 1512.

With such a configuration, at the reception position P00, the plate PL is placed in a state the placement portion 51 is in the horizontal posture. Thereafter, the placement portion 51 is inclined at the providing position P10, the observation object OB is placed on the liquid supplied from the nozzle 1531 to include the fixing position OC on the inclined plate PL, and then the liquid starts to be discharged by the liquid discharge portion 56. When the liquid is discharged from the placement portion 51 in the inclined posture, the observation object OB is gradually fixed on the plate PL from the reception portion 55 side toward the liquid discharge portion 56 side, and the entire surface of the observation object OB is fixed to the fixing position OC on the plate PL when the discharge of the liquid is completed. Note that when the liquid is discharged from the placement portion 51 in the inclined posture, it is also possible to improve the liquid discharge efficiency by further inclining the placement portion 51.

FIG. 6 is a perspective view illustrating a configuration example capable of realizing detection and identification of the guide member 411, and mainly illustrates a positional relationship between the pair of sensors 42 and the pair of opening portions 531 in the present example. As described above, the pair of opening portions 531 is located on the optical axis L42 of the pair of sensors 42.

For distinction, one sensor 42 is referred to as a sensor 42a, its optical axis L42 is referred to as an optical axis L42a, and one opening portion 531 corresponding to the sensor 42a is referred to as an opening portion 531a. Similarly, the other sensor 42 is referred to as a sensor 42b, its optical axis L42 is referred to as an optical axis L42b, and the other opening portion 531 corresponding to the sensor 42b is referred to as an opening portion 531b.

For example, the sensor 42a outputs a low-level signal (L signal) when the opening portion 531a is detected, and outputs a high-level signal (H signal) when the opening portion 531a is not detected (here, when the optical axis L42a is blocked by the guide member 411). Similarly, the sensor 42b outputs the L signal when the opening portion 531b is detected, and outputs the H signal when the opening portion 531b is not detected. Note that detection of the pair of opening portions 531 by the pair of sensors 42 is performed in a state where the holding unit 1512 (placement portion 51) is in the horizontal posture.

FIG. 7 illustrates three types of guide members 411a, 411b, and 411c as examples of the guide member 411 attachable to the holding unit 1512. These are each housed at the position corresponding to the identification display portion 412 in the housing portion 410, and can be selectively attached to the holding unit 1512.

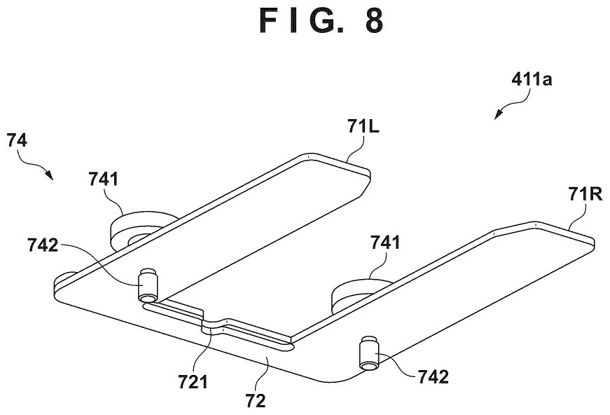

FIG. 8 illustrates, as an example, a perspective view of the guide member 411a as viewed from below.

In the following description, in a case where the guide members 411a, 411b, and 411c are not particularly distinguished, the guide members 411a, 411b, and 411c are simply referred to as the guide member 411.

The guide member 411 includes a guide portion 71, a connection portion 72, a liquid-repellent portion 73, a mounting portion 74, and a covering portion 75. The guide portion 71 is provided to be able to guide the observation object OB to a predetermined position, and includes a pair of left and right attachment members 71L and 71R in the present example. The connection portion 72 connects the pair of attachment members 71L and 71R. The distance between the pair of attachment members 71L and 71R may be determined on the basis of the size of the plate PL and the size of the observation object OB. That is, when a plate PL is received from the transport unit 112 at the reception position P00, the attachment members 71L and 71R are positioned on both sides of the plate PL.

Here, as illustrated in FIG. 8, a recess 721 is formed in the connection portion 72, and the connection portion 72 can be fitted to the liquid discharge portion 56 by the recess 721. The recess 721 functions as an alignment portion for aligning the guide member 411.

The liquid-repellent portion 73 is formed on the surfaces of the pair of attachment members 71L and 71R and the connection portion 72, and can be formed at least on the upper surfaces thereof by, for example, water repellent finish. As indicated by a broken line in the drawing, the liquid-repellent portion 73 is formed only on the inner side of the C-shaped frame formed by the upper surface of the pair of attachment members 71L and 71R and the connection portion 72 among the upper surface of the pair of attachment members 71L and 71R and the connection portion 72.

According to such a configuration, the liquid supplied to the plate PL by the nozzle 1531 of the liquid supply unit 153 at the providing position P10 is retained on the plate PL by the liquid-repellent effect (water repellent effect) of the liquid-repellent portion 73, and a liquid reservoir is formed. Then, the observation object OB on the liquid reservoir formed on the plate PL can be appropriately guided within the frame of the pair of attachment members 71L and 71R and the connection portion 72.

Note that the shapes of the guide portion 71, the connection portion 72, and the liquid-repellent portion 73 described above are different from each other among the guide members 411a to 411c. Therefore, the guide members 411a to 411c can be selectively used according to the use such as the shape, size, and type of the observation object OB.

The mounting portion 74 is used to attach the main body of the guide member 411 to the attachment portion 52 of the holding unit 1512. In this example, as illustrated in FIG. 8, the mounting portion includes a fixing portion 741 and an aligned portion 742. The fixing portion 741 is used to fix the guide member 411 to the attachment portion 52. The aligned portion 742 corresponds to the screw hole 521 which is one of the alignment portions of the guide member 411 (see FIG. 5). A pair of right and left fixing portions 741 and a pair of right and left aligned portions 742 are provided corresponding to the pair of attachment members 71L and 71R, respectively.

In the present embodiment, the fixing portion 741 may be a head of a screw, the aligned portion 742 may be a screw corresponding to the screw hole 521, and the guide member 411 may be attached to the attachment portion 52 by screwing. As another embodiment, for example, when a metal member is provided instead of the screw hole 521, the fixing portion 741 may be a gripping portion and the aligned portion 742 may be a magnet.

Note that the configuration of the mounting portion 74 described above is the same among the guide members 411a to 411c, and any one of the guide members 411a to 411c can be used.

In the following description, a state in which any one of the guide members 411a to 411c is not attached to the holding unit 1512 can be expressed as a non-attached state (non-mounted state). A state in which any one of the guide members 411a to 411c is attached to the holding unit 1512 can be expressed as an attached state (mounted state).

The covering portion 75 is provided on each of the pair of attachment members 71L and 71R corresponding to the identification assist portion 53, at least partially covers the identification assist portion 53, and in the present example, closes at least one of the pair of opening portions 531a and 531b. As illustrated in FIG. 7:
the guide member 411a closes both the opening portions 531a and 531b;
the guide member 411b closes one of the opening portions 531a and 531b (here, the opening portion 531b); and
the guide member 411c closes the other of the opening portions 531a and 531b (here, the opening portion 531a).

According to such a configuration, the control unit 17 can determine the presence or absence of the guide member 411 on the basis of the detection results of the pair of sensors 42a and 42b, and identify the type of the guide member 411 if any guide member exists (see FIGS. 5 to 6).

For example,
it is determined by the control unit 17 that:
in a case where both the sensor 42a and the sensor 42b output the L signal, the holding unit 1512 is in the non-attached state; and
in a case where one or both of the sensor 42a and the sensor 42b output the H signal, the holding unit 1512 is in the attached state.

Furthermore,
it is determined by the control unit 17 that:
in a case where the sensor 42a outputs the H signal and the sensor 42b outputs the H signal, the guide member 411 attached to the holding unit 1512 is the guide member 411a;
in a case where the sensor 42a outputs the H signal and the sensor 42b outputs the L signal, the guide member 411 attached to the holding unit 1512 is the guide member 411b; and
in a case where the sensor 42a outputs the L signal and the sensor 42b outputs the H signal, the guide member 411 attached to the holding unit 1512 is the guide member 411c.

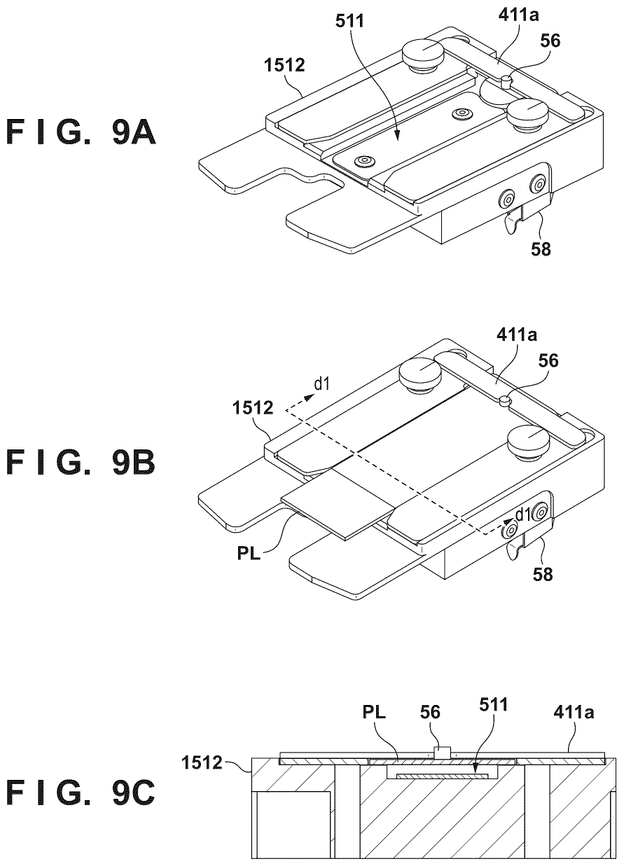

FIG. 9A is a perspective view of the holding unit 1512 to which where the guide member 411a is attached. FIG. 9B is a perspective view of a state where the plate PL is held by the holding unit 1512 to which the guide member 411a is attached. FIG. 9C illustrates a schematic cross-sectional view in which a line d1-d1 in FIG. 9B is set as a cut section.

As described above, the recessed portion 511 is continuously formed toward the liquid discharge portion 56, so that the excess liquid supplied from the nozzle 1531 of the liquid supply unit 153 at the providing position P10 can be collected in the liquid discharge path 57 through the recessed portion 511.

### Procedure of Specimen Preparation Work

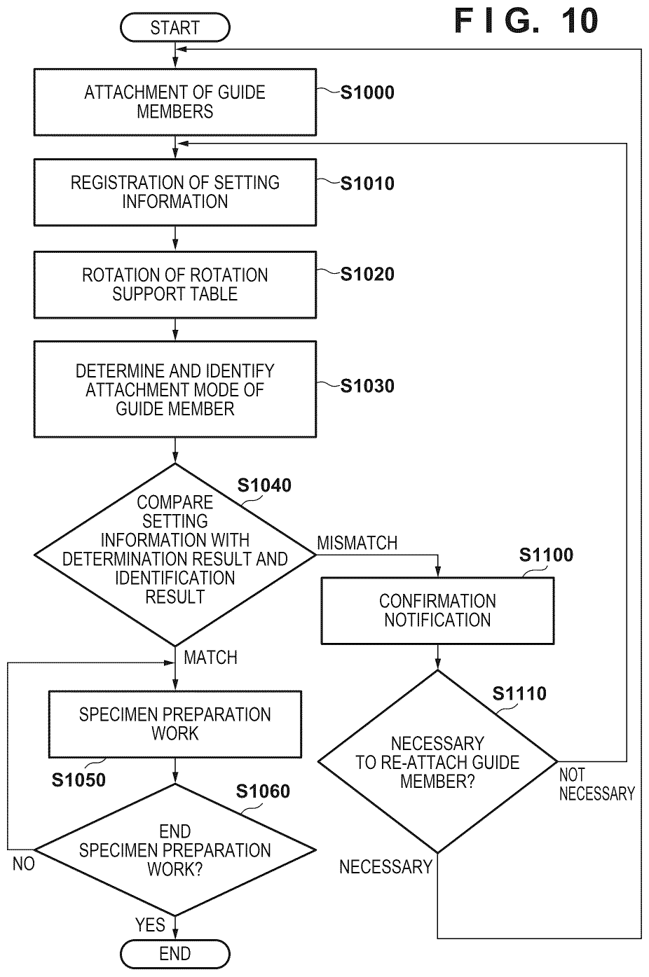

FIG. 10 is a flowchart illustrating an example of a procedure when preparing the observation specimen SPL. The present flowchart is mainly performed by the worker and/or the control unit 17.

In step S1000 (Hereinafter, simply referred to as “S1000”. The same applies to other steps to be described later.), the worker attaches a corresponding one of the guide members 411a to 411c to each of the plurality of holding units 1512. Note that the plurality of guide members 411 attached to the plurality of holding units 1512 may be the same in order to prevent confusion, but may be partially different depending on a predetermined use.

In S1010, the worker sets the specimen preparation information including the information of the guide member 411 attached in S1000 as the setting information. As another example of the setting information, information for managing the observation specimen SPL such as the type and attribute of the observation specimen SPL can be included. This work is performed via the input terminal 97, and the setting information is registered in the computer 95. As a result, the worker can confirm the contents of the observation specimen SPL prepared in and after this step.

In S1020, in response to the registration in S1010, the control unit 17 rotates the rotation support table 1511 on the basis of the communication between the specimen preparation device 1 and the computer 95.

In S1030, the control unit 17 sequentially determines whether the holding unit 1512 sequentially moved to the reception position P00 by the rotation of the rotation support table 1511 is in the attached state (state in which the guide member 411 is attached) or the non-attached state (state in which the guide member 411 is not attached), and further identifies the type of the attached guide member 411 if the holding unit is in the attached state. The determination and identification are performed on the basis of the detection results of the sensors 42a and 42b.

In S1040, the setting information registered in the computer 95 in S1010 is compared with the information indicating the determination result and the identification result obtained in S1030 on the basis of the communication between the specimen preparation device 1 and the computer 95. The comparison may be performed by the control unit 17, or may be performed by the computer 95 on the basis of the communication between the specimen preparation device 1 and the computer 95.

In a case where all of the determination results and the identification results obtained in S1030 correspond to the setting information registered in the computer 95 in S1010, the processing proceeds to S1050, and otherwise, the processing proceeds to S1100. For example, in a case where the information indicating that the guide member 411 is not attached and the information identifying the type of the guide member 411 if the guide member is attached match the setting information registered in S1010, the processing proceeds to S1050.

As it is determined that the attachment mode of the guide member 411 is different from the content of the setting information registered in S1010, a confirmation notification for prompting confirmation is output to the worker in S1100. The confirmation notification is output to the display terminal 96.

In S1110, confirmation is performed by the worker, and if it is not necessary to re-attach the guide member 411, the processing returns to S1010. On the other hand, if it is necessary to re-attach the guide member 411, the processing returns to S1000.

In S1050, after completion of S1030 to S1040, the worker can perform a specimen preparation work, and specifically, while taking out the observation object OB from the observation object preparation device 92, provides the observation object OB to the plate PL of the holding unit 1512 sequentially moved to the providing position P10 by the operation input using the input device 94.

In S1060, the control unit 17 determines whether or not to end the specimen preparation work. If the worker ends the specimen preparation work, the worker can give an end instruction via the input terminal 97. The determination is made on the basis of the communication between the specimen preparation device 1 and the computer 95. This flowchart ends when the specimen preparation work is ended, and otherwise, the processing returns to S1050.

In short, the worker attaches a desired one of the guide members 411a to 411c to the plurality of holding units 1512. After the attachment of the guide member 411 is completed, the worker registers the setting information in the computer 95 by operation input using the input terminal 97. Accordingly, in the specimen preparation device 1, the control unit 17 rotates the rotation support table 1511 to identify the type of the guide member 411 attached to each of the plurality of holding units 1512. Thereafter, the worker provides the observation object to the plate PL of the holding unit 1512 sequentially moved to the providing position P10 by the operation input using the input device 94. The observation specimen SPL thus prepared is sequentially stored in the specimen storage unit 13 by the transfer unit 14. The worker performs information management of the observation specimen SPL while referring to the display terminal 96 as necessary.

According to the present embodiment, the control unit 17 identifies the guide members 411 attached to each holding unit 1512, and performs control for preparing the observation specimen SPL on the basis of the result. For example, in a case where the attachment mode of the guide member 411 is intended by the worker, the worker can appropriately perform the specimen preparation work. On the other hand, in a case where the attachment mode of the guide member 411 is not intended by the worker, the confirmation notification is output, and the worker does not mistake the type of the observation object OB to be provided to the plate PL. Therefore, according to the present embodiment, the observation specimen OB can be fixed at a predetermined position on the plate PL and the fixed position thereof can be adjusted, so that the observation specimen SPL can be more appropriately prepared.

In the above description, each element is indicated by a name related to its function for facilitating understanding, but each element is not limited to the one having the content described in the embodiment as a main function, and may be the one having the content as an auxiliary function. In addition, the individual terms described herein are merely used for the purpose of describing the present invention, that is, the present invention is not limited to the strict meaning of the terms. For example, the term “apparatus” may be replaced with a term “unit/assembly/device/module”, or vice versa. In addition, for example, instead of the term “move” with respect to a symmetric object, it may be expressed as “convey”/“transfer” or the like, and vice versa.

The invention is not limited to the foregoing embodiments, and various variations/changes are possible within the spirit of the invention.

### REFERENCE SIGNS LIST

1 Specimen preparation device
PL Plate
OB Observation object
SPL Observation specimen
1511 Rotation support table
1512 Holding unit
17 Control unit
411 Guide member

1. A specimen preparation device configured to prepare an observation specimen by providing an observation object placed in a liquid reservoir formed on a light transmissive plate to the plate while guiding the observation object to a predetermined position by a guide member, the specimen preparation device comprising:
a plurality of holding means, each configured to be able to hold the plate, the guide member being attachable to each holding means;
moving means configured to be able to sequentially move the plurality of holding means to a providing position for providing the observation object; and
control means configured to identify the guide member attached to each holding means at an identification position and perform control for preparing the observation specimen on a basis of a result of the identification.

2. The specimen preparation device according to claim 1, further comprising
detection means for detecting the guide member attached to each holding means at the identification position, wherein
the control means identifies the guide member on a basis of a detection result by the detection means.

3. The specimen preparation device according to claim 2, wherein
the control means performs:
a first control for sequentially identifying types of the guide members attached to the plurality of holding means while sequentially moving the plurality of holding means with respect to the detection means by the moving means on a basis of a first operation input; and
a second control for sequentially moving the plurality of holding means to the providing position by the moving means on a basis of a second operation input, and
determines whether to perform the second control on a basis of the identification result obtained in the first control.

4. The specimen preparation device according to claim 3, further comprising
display means for displaying a state of the specimen preparation device, wherein
the display means further displays the identification result obtained in the first control.

5. The specimen preparation device according to claim 3, further comprising storage means for storing setting information input by an external operation, wherein the control means determines whether to perform the second control on a basis of a result of comparison between the stored setting information and the identification result obtained in the first control.

6. The specimen preparation device according to claim 1, further comprising housing means for housing the guide member, wherein
the housing means includes:
a housing portion configured to house the guide member for each type; and
an identification display portion configured to indicate a type of the guide member, the identification display portion disposed corresponding to a housing position of each type.

7. The specimen preparation device according to claim 2, wherein
each holding means includes an identification assist portion configured to assist identification of the guide member by the control means,
the detection means is further capable of detecting the identification assist portion, and
the control means identifies a non-attached state in which the guide member is not attached to the holding means and an attached state in which the guide member is attached to the holding means on a basis of a detection result of the identification assist portion by the detection means, and identifies a type of the attached guide member in the attached state.

8. The specimen preparation device according to claim 7, wherein
each holding means further includes:
a placement portion on which the plate is able to be placed; and
an attachment portion for attaching the guide member, the attachment portion being provided to surround the placement portion,
a pair of the identification assist portions is provided on both sides of the placement portion on the attachment portion, and
the detection means detects each of the pair of identification assist portions.

9. The specimen preparation device according to claim 8, wherein
the attachment portion is provided with an alignment portion for aligning the guide member.

10. The specimen preparation device according to claim 8, further comprising liquid supply means for supplying liquid to the plate held by each holding means, wherein
the placement portion is provided with a liquid discharge portion for discharging liquid.

11. The specimen preparation device according to claim 10, wherein
in the placement portion, a reception portion configured to receive the plate is provided facing the liquid discharge portion, and
the specimen preparation device further comprises an inclination means for performing an inclination movement of the placement portion so as to be movable between a first position, which is a position of the reception portion when the reception portion receives the plate into the placement portion, and a second position, which is a position of the reception portion where the liquid discharge portion is below the reception portion.

12. The specimen preparation device according to claim 10, wherein
the placement portion is provided with a recessed portion with respect to a placement surface on which the plate is placed in contact, and
the recessed portion is continuously formed toward the liquid discharge portion.

13. A guide member selectively attachable to the plurality of holding means included in the specimen preparation device according to claim 1, wherein each holding means includes an identification assist portion configured to assist identification of the guide member by the control means,
the guide member comprises:
a guide portion configured to guide the observation object;
a mounting portion used for attachment to the attachment portion; and
a covering portion configured to at least partially cover the identification assist portion.

14. The guide member according to claim 13, comprising
a pair of attachment members positioned on both sides of the plate held by each holding means and attached to the holding means as the guide portion, and
further comprising a connection portion configured to connect the pair of attachment members.

15. The guide member according to claim 14, wherein
a pair of the attachment portions is provided on both sides of the placement portion, and
the covering portion is provided on each of the pair of attachment members corresponding to the identification assist portion provided on each of the pair of attachment portions.

16. The guide member according to claim 14, wherein
a liquid-repellent portion is provided on at least upper surfaces of the pair of attachment members and the connection portion.

17. The guide member according to claim 14, wherein
the mounting portion includes:
a fixing portion provided on the pair of the attachment member and configured to be fixed to the holding means when the attachment member is attached to each holding means; and
an aligned portion provided on the pair of the attachment member and configured to align the guide member.
